(19) United States
(12) Patent Application Publication
(10) Pub. No.: US 2014/0089117 A1
(43) Pub. Date: Mar. 27, 2014

(54) Secure Escrow Transaction System

(71) Applicant: CURENCI, LLC, Bloomington, MN (US)

(72) Inventor: Dale Allan Schumacher, Minneapolis, MN (US)

(73) Assignee: CURENCI, LLC, Bloomington, MN (US)

(21) Appl. No.: 13/834,966

(22) Filed: Mar. 15, 2013

Related U.S. Application Data
(60) Provisional application No. 61/704,962, filed on Sep. 24, 2012.

(51) Int. Cl. G06Q 20/40

(52) U.S. Cl. CPC G06Q 20/40
USPC 705/21; 705/40

(57) ABSTRACT

A method and device for conducting a secure transaction, where a buyer and seller have account information on an escrow server including assigned buyer and seller account identification numbers, the buyer and seller authenticate their identities using respective devices, the seller constructs an offer template using their seller device where the offer template includes the seller account number combined with information sufficient to identify the item(s) being sold, the item(s) price and the total amount of the transaction, the buyer communicates their buyer account number to the seller device, the seller combines the buyer account number with the offer template to create a digitally signed offer which is sent to the escrow server, the escrow server then generates and communicates an escrow code to the parties, whereupon payment authorization of the escrow transaction may be completed.

### BACKGROUND OF THE INVENTION

A typical retail purchasing transaction using a credit card involves a Buyer handing their Credential (the credit card) to a Seller, who uses that Credential to obtain a Payment. This exposes the Buyer to the risk that the Seller may use the Buyer's Credential to obtain a Payment that the Buyer would not authorize. The invention proposes to address this risk by providing a mechanism by which the Buyer can authorize Payment without exposing any Credential to the Seller.

### SUMMARY OF THE INVENTION

The present invention is concerned with facilitating the secure exchange of value between a Buyer and a Seller, without exposing the Buyer's Credential, and protecting the Seller from repudiation of a Payment. The general strategy used to accomplish this is to provide a System that acts as an Escrow Agent. The System facilitates the construction of an Offer, signed by the Seller, describing the Terms and Conditions of the Escrow. The System generates a secure Escrow Code representing the Escrow Transaction. The System receives instructions for Payment, signed by the Buyer. If the Terms and Conditions are met, the System settles the Escrow Transaction, and provides confirmation of settlement to both parties.

### DESCRIPTION OF THE FIGURES

FIG. 1 is a block diagram illustrating at least one embodiment of the system for the secure escrow transaction process.

FIG. 2 is a block diagram illustrating at least one embodiment of the secure escrow transaction process.

FIG. 3 is a block diagram illustrating at least one embodiment of the Generate Secure Escrow Process in additional detail.

FIG. 4 is a block diagram illustrating at least one embodiment of the Settle Escrow Transaction Process in additional detail.

FIG. 5 is a block diagram illustrating at least one embodiment of the flow of messages between the Seller, the Escrow System and the Buyer.

FIG. 6 is a block diagram illustrating at least one embodiment of the various states of an Offer and the events causing transitions among those states.

FIG. 7 is a block diagram illustrating at least one alternative embodiment of the flow of messages between the Seller, the Escrow System and the Buyer.

### DETAILED DESCRIPTION

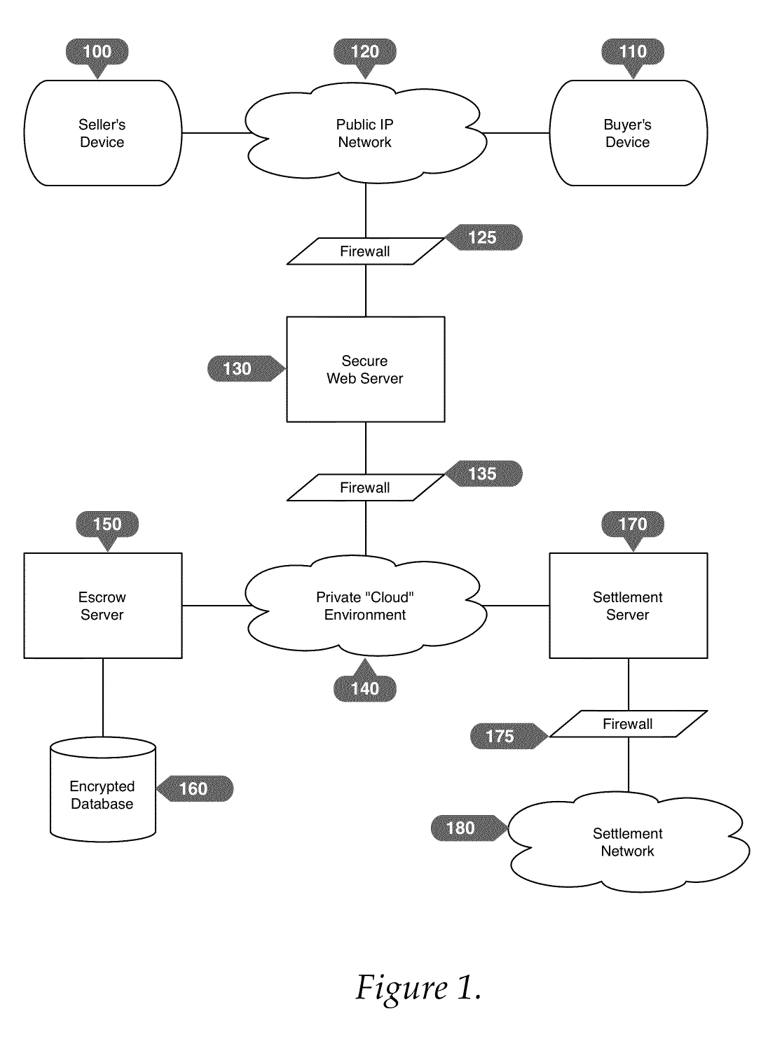

FIG. 1 is a block diagram illustrating the primary components of the invention in the preferred embodiment. The Seller's Device 100 and the Buyer's Device 110 are connected to a public (unsecured) Internet Protocol (IP) network 120 such as “the Internet”.

Both the Seller's Device 100 and the Buyer's Device 110 may make connections to the Web Server 130 through a Firewall 125. The Firewall 125 and Web Server 130 are configured to allow only secure connections using Secure Sockets Layer/Transport Layer Security (SSL/TLS). This prevents any device between the Buyer 110 or Seller 100 and the Server 130 from eavesdropping on, or tampering with, the communication.

An additional Firewall 135 controls the flow of information between the Web Server 130 and the servers hosted in the Private “Cloud” Environment 140. In general, this Firewall 135 only allows connections initiated by the Web Server 130, protecting the Cloud Environment 140 from the Public Internet 120.

The Escrow Server 150, Encrypted Database 160, and the Settlement Server 170, embody the secure escrow settlement mechanism. The Escrow Server 150 is primarily responsible for performing cryptographic functions and managing active escrow transactions. The Encrypted Database 160 securely stores the escrow transaction data.

The Settlement Server 170 is primarily responsible for performing accounting for exchanges of value specified by the escrow terms, and enacting settlement through outside services as needed to fulfill the escrow terms. The Firewall 175 controls the flow of information between the Settlement Server 170 and the outside services reachable through the Settlement Network 180. Depending on the specific embodiment, and the requirements of the outside services, the Settlement Network 180 may actually be the same as the Public Network 120.

Someone skilled in the art will recognize that the Web Server 130 may, in fact, be a cluster of servers and load balancing devices, allowing for high availability, fail-over and fault-tolerance. This strategy, for scalability to handle high traffic loads, may be applied to any of the Servers 130, 150, 170, etc. In addition, the Database 160 may be distributed, sharded or replicated for similar reasons.

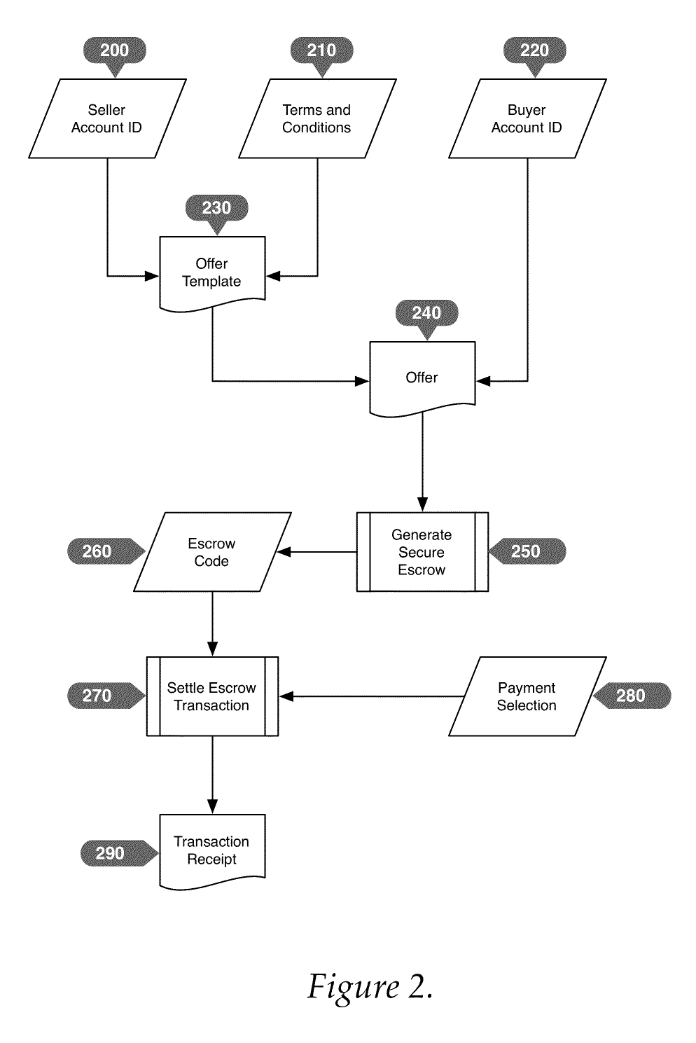

FIG. 2 illustrates, in general terms, the secure escrow transaction process. The Seller Account ID 200 is combined with the Terms and Conditions 210 to create an Offer Template 230. The Offer Template 230 is combined with the Buyer Account ID 220 to create the Offer 240. In some embodiments, the Offer Template 230 is not created explicitly. Instead, the Offer 240 may be created directly from the Seller Account ID 200, the Terms and Conditions 210, and the Buyer Account ID 220. In some embodiments any of the elements of the Seller Account ID 200; terms and conditions 210; Offer Template 230; Buyer Account ID 220; and/or the Offer 240 maybe encrypted or otherwise encoded.

The information in the Offer 240 is used by the Generate Secure Escrow process 250 to create the Escrow Code 260 for this transaction. The Settle Escrow Transaction Process 270 is triggered by the Payment Selection 280, and produces a Transaction Receipt 290 on successful completion. In some embodiments, any of the elements of the generate Secure Escrow Process 250; Escrow Code 260; Settlement Escrow Transaction Process 270; Payment Selection 280 and/or the Transaction Receipt 290 may by encrypted or otherwise encoded.

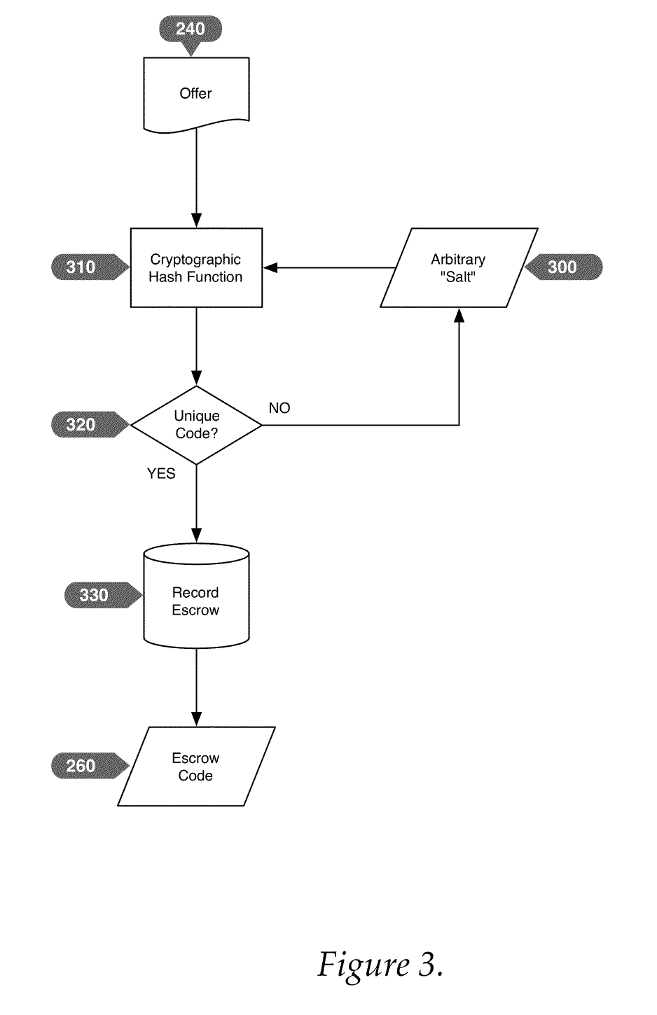

FIG. 3 illustrates the Generate Secure Escrow Process (250 from FIG. 2) in more detail. Selected information from the Offer 240 is combined with Arbitrary “Salt” 300 to compute a Cryptographic Hash Function 310. The information selected from the Offer 240 includes any information deemed important to verify the integrity of the transaction. In various embodiments, this may include identification of the Buyer and Seller, item description(s) and price(s), total transaction value, creation date/time and expiration date/time.

The Arbitrary “Salt” 300 is generated by the Escrow Server 150. It consists of unpredictable information, which is combined with information from the Offer 240 to strengthen the output of the Cryptographic Hash Function 310. In some embodiments, the salt is derived from fast-changing information such as a microsecond-resolution server timestamp. The salt may also include a random number from a cryptographically strong generator, or a source of true randomness, if available to the Escrow Server 150.

The output of the Cryptographic Hash Function 310 is checked for uniqueness within the system. If the generated code is not unique, the Escrow Server 150 generates a new Arbitrary “Salt” 300, and recalculates the Cryptographic Hash Function 310, generating a new code. This process continues until a unique code is generated and the Record Escrow 330 process has persisted the code in the Encrypted Database 160. The final product of the Generate Secure Escrow Process 250 is the Escrow Code 260.

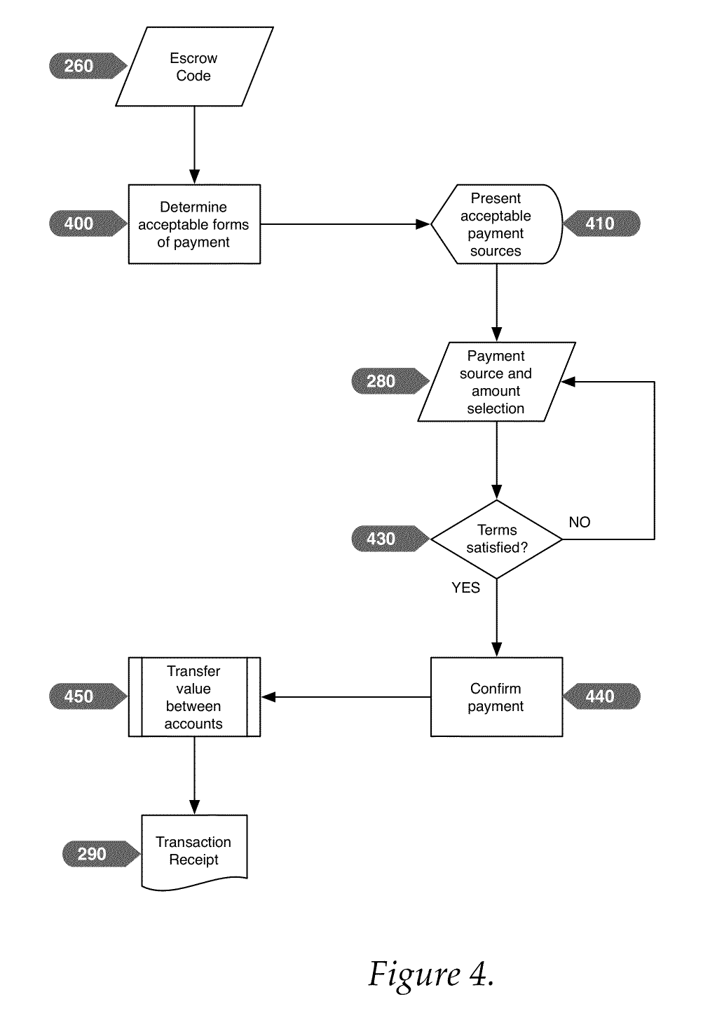

FIG. 4 illustrates the Settle Escrow Transaction Process (270 from FIG. 2) in more detail. Once the Escrow Code 260 has been generated for a transaction, we have a digitally-signed Offer from the Seller. Now we must obtain a digitally-signed Payment from the Buyer.

The acceptable forms of Payment 400 are determined by consulting the details of the Offer 240 and filtering them based on the Buyer's available payment sources. The acceptable, and available, Payment Sources are Presented 410 to the Buyer. The Buyer selects from the available sources and specifies the amount to be Paid 280. If the terms are Not Satisfied 430 by the specified selection(s), additional sources and amounts may be selected until the terms are satisfied. The Buyer confirms the final selection of payment Sources and Amounts 440. This confirmation constitutes a digital signature of the Buyer's acceptance of the Seller's Offer.

With digital signatures confirming both parties' agreement to the terms of the Offer, the Escrow Server 150 settles the transaction by transferring the agreed-upon value between Accounts 450. In some embodiments, settlement may involve subordinate transactions with external systems via the Settlement Server 170. External settlement may involve obtaining Promises, based on contractual commitments, on which basis the transfer of value may be completed even if external compensation is delayed.

A Transaction Receipt 290 confirms the successful settlement of the transaction. This receipt is persistently available to both the Buyer and Seller. In some embodiments, the receipt is proactively transmitted to each party.

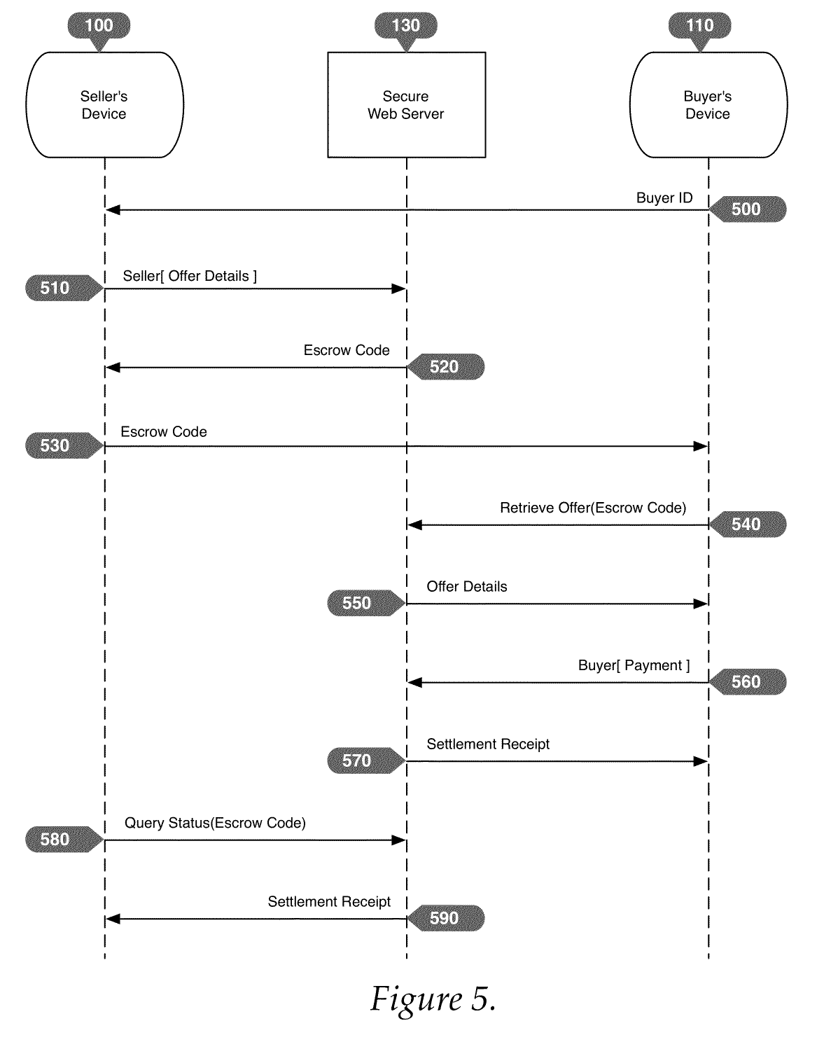

FIG. 5 illustrates the flow of messages between the Seller, the Escrow System and the Buyer in a typical embodiment. The Seller interacts via the Seller's Device 100. The Escrow System interacts via the Secure Web Server 130. The Buyer interacts via the Buyer's Device 110. Interactions among the components of the Escrow System are hidden behind the Secure Web Server 130.

An Offer defines a unique single transaction, consisting of a Buyer, a Seller and a collection of Terms and Conditions. Additional information may also be associated with an Offer, including details such as time-stamps, order tracking numbers, etc. which help to uniquely identify this Offer from any similar Offers. In many embodiments, the final piece of information required to create an Offer is the Buyer ID, thus the message flow begins with the Buyer sending their ID to the Seller 500 or Offer 240.

The Seller may use the Buyer ID to obtain additional information about the Buyer, including but not limited to; name on the account, phone number, email address and image of the account holder. The Buyer's choice to make this information available can increase the security of a transaction, and may be encouraged or even required by some Sellers. In at least one embodiment, the Seller combines the Buyer ID 500 with the rest of the Offer Details, digitally signs the bundle, and sends it to the System 510.

The System validates the Offer Details, generates an Escrow Code for this Offer, and sends it to the Seller 520. Although the Escrow Code is actually generated by the Escrow Server (as previously described), this interaction is hidden behind the Secure Web Server 130, thus from the perspective of the Buyer's Device 110 and the Seller's Device 100, interaction with the System is interaction with the Secure Web Server 130.

The Seller sends the Escrow Code to the Buyer 530.

The Buyer uses the Escrow Code to request the Offer Details from the System 540. Note that this constitutes independent verification of the legitimacy of the Offer and validation of both parties to the transaction.

The system sends the Offer Details to the Buyer 550.

The Buyer selects payment sources and amounts consistent with the Terms and Conditions of the Offer, digitally signs the Payment, and sends it to the System 560.

The system settles the transaction, generates a Settlement Receipt, and sends it to the Buyer 570.

Afterward, the Seller (or Buyer) may use the Escrow Code to query the status of the Transaction 580.

Whereupon, the System sends a copy of the Settlement Receipt 590. In some embodiments, certain transaction details may be redacted from the Settlement Receipt based on which party made the request.

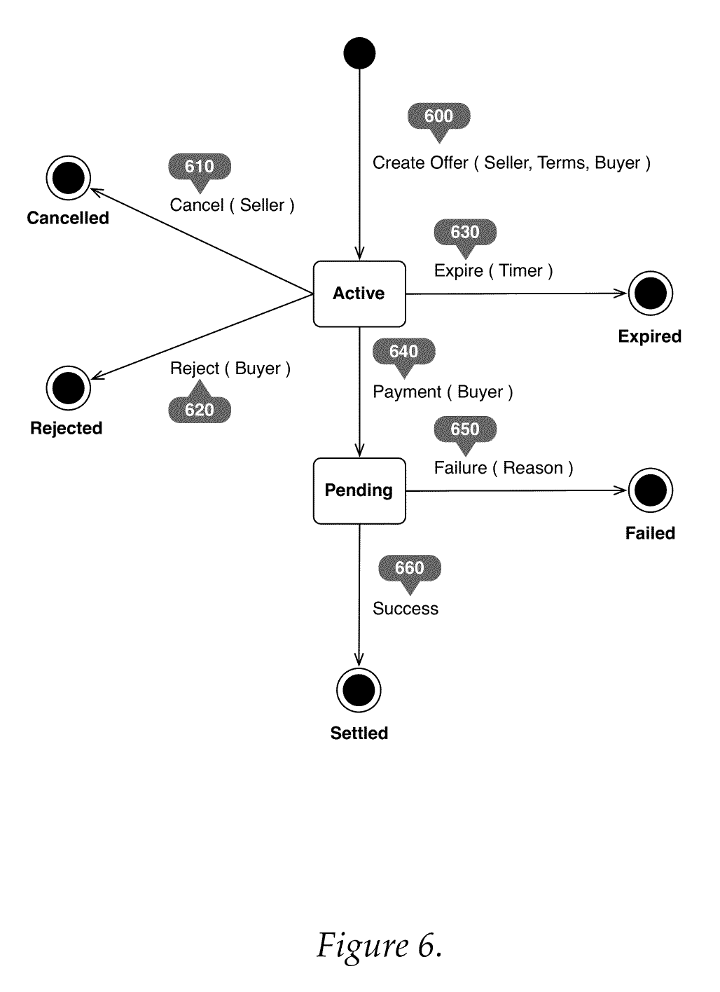

FIG. 6 illustrates the various states of an Offer and the events that cause transitions among those states. An Offer is created with information about the Seller, Terms and Buyer 600. The Offer is initially in “Active” state.

The Seller may Cancel an “Active” Offer 610, moving it to a final “Canceled” state.

The Buyer may Reject an “Active” Offer 620, moving it to a final “Rejected” state.

In some embodiments, the Terms of the Offer may include a period of time in which the Offer is valid. In such a case, the System may Expire an “Active” Offer 630, moving it to a final “Expired” state.

The Buyer may submit a Payment for an “Active” Offer 640, moving it to “Pending” state, and initiating the settlement process.

If settlement for a “Pending” Offer fails, the system records the Failure (and optional Reason) 650, moving the Offer to a final “Failed” state.

If settlement for a “Pending” Offer succeeds, the system records the Success 660, moving the Offer to a final “Settled” state.

Note that each state is entered at most once and events not shown here have no effect on the state of an Offer.

In some embodiments, the System may appear to allow an Offer in “Settled” state to be Refunded. However, this is implemented by creating a separate compensating Offer. Such an Offer may be associated with the original Offer, for tracking purposes.

In at least one embodiment, the invention involves the Seller and the Buyer both having a Mobile Device 100/110 with a means of communication to the Secure Escrow Transaction System. In some embodiments, the means of communication is an HTTPS connection through the Internet 120 to a Secure Web Server 130, although alternative means of communication will be obvious to those skilled in the art. In some embodiments, the Seller's Device 100 and the Buyer's Device 110 may also have the ability to communicate directly using, for example, their displays and cameras to display/read barcodes, or their accelerometers to recognize a “bump” gesture correlated to proximity of the devices. Many alternative means of direct communication will be obvious to those skilled in the art, including simulation of a “direct” communication via forwarding through the Secure Web Server 130.

Authentication of the Buyer and Seller may be performed by the Buyer's Device 110 and Seller's Device 120 respectively. This can be accomplished through a variety of means including, but not limited to; password, pass-phrase, PIN number or biometric identification (e.g.: fingerprint, voice, retinal scan or facial recognition); or some combination. Their authorization to conduct transactions in their respective accounts is validated by the System during each interaction with the Secure Web Server 130.

The Seller constructs an Offer Template 230 on their device. The Buyer sends their Account ID 220 from their device to the Seller's device using, for example, a barcode displayed on the Buyer's device and scanned by the Seller's device. The Seller combines the Buyer's ID with the Offer Template to create, and digitally sign, an Offer 240. The System generates an Escrow Code 260 for the Offer, which is sent from the Seller to the Buyer, again using a barcode or other scanning or combination process.

The Buyer uses the Escrow Code to obtain the Offer Details from the System, verifying the legitimacy of the Offer. The Buyer constructs a Payment 280 for the Offer on their device and sends it to the System for settlement. There is no need for the Buyer's Device to carry the credentials required to settle the transaction. The Buyer need only indicate to the System what pre-configured credentials should be used as a source of payment. A receipt confirming the status of the transaction 290 is available to both the Buyer and Seller.

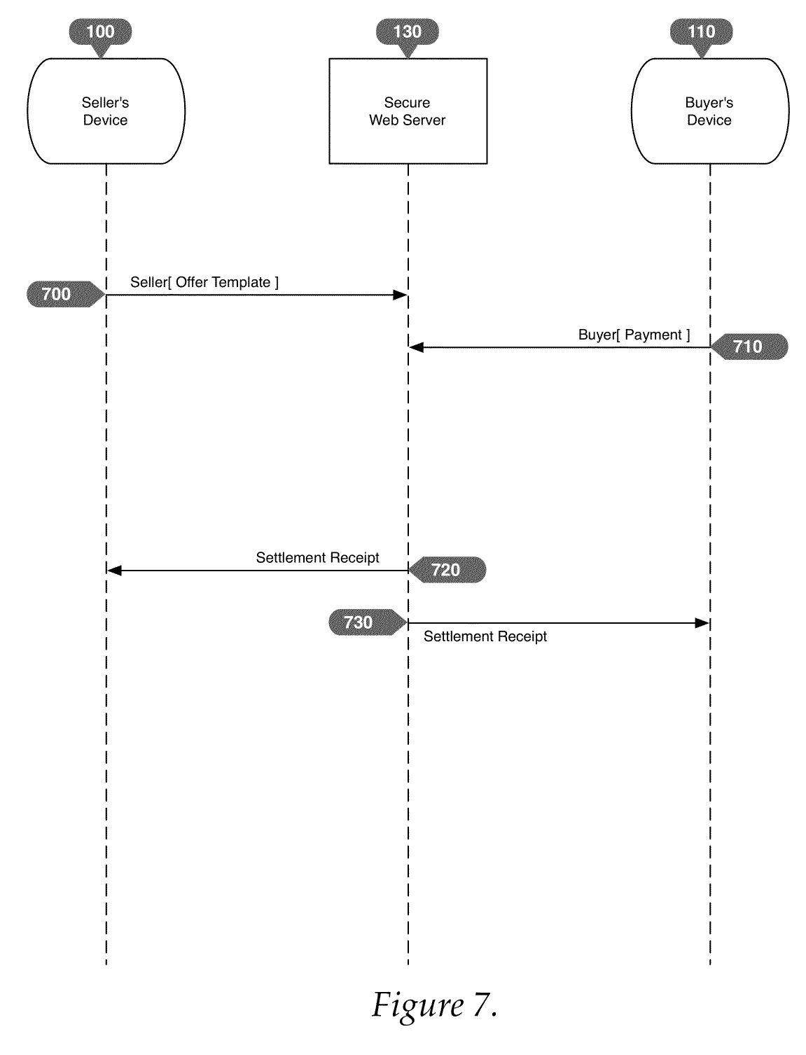

FIG. 7 illustrates the flow of messages between the Seller, the Buyer, and the Escrow System (represented by the Secure Web Server 130) in an embodiment involving the use of a “bump” gesture, where both the Seller's Device 100 and the Buyer's Device 110 register a “bump” at approximately the same time in approximately the same physical location. In this embodiment, the Seller prepares an Offer Template 230 and prepares the Seller's Device to register a “bump”. Concurrently, the Buyer prepares a Payment Selection 280 and prepares the Buyer's Device to register a “bump”. When the Seller's Device 100 registers a “bump”, it sends the Offer Template 230, signed by the Seller, to the System 700. When the Buyer's Device registers a “bump”, it sends the Payment Selection 280, signed by the Buyer, to the System 710. If the System receives both transmissions within a reasonably short period of time, and the devices indicate that they are within proximity of each other, the System will combine the transmissions into an Escrow Transaction.

The System will internally create an Offer 240, and from it generate an Escrow Code 260. Since both Seller and Buyer have digitally signed their consent to enter into this transaction, the System immediately settles the transaction. The System generates a Settlement Receipt 290 referencing the Escrow Code 260. As confirmation of the settlement, the System sends the Settlement Receipt 290 to the Seller 720 and to the Buyer 730.

In another embodiment, the Seller has a mobile device, but the Buyer does not. In this case, the Buyer must provide their Buyer ID 220 in some other form, so the Seller can create the Offer 240. The Buyer may provide their Buyer ID 220 by presenting a physical representation, such as a barcode or ID number on a printed card. The Buyer ID 220 is not a payment credential, so it can be carried openly and freely shared.

Once the Seller has created the Offer 240 and the System has generated the Escrow Code 260, the application on the Seller's Device can request authentication from the Buyer. If the Buyer trusts the legitimacy of the Seller's Device (and the authenticity of the application), the Buyer can provide authentication, select the source(s) and amount(s) for payment, and authorize settlement of the transaction. The resulting Transaction Receipt 290 confirms successful settlement for both parties. Either party may re-confirm the transaction later, through other channels such as online account records.

In another embodiment, the Seller's Device 100 is an electronic point-of-sale (POS) system. As long as the POS can communicate with the Secure Escrow Transaction System, it can fulfill the role of Seller. If the Buyer does not have a mobile device, then the Buyer may be required to be authenticated, select and authorize payment using a device that is part of the POS (e.g.: a PIN pad or touch-screen).

If the Buyer has a mobile device, the POS can obtain the Buyer ID 220, create the Offer 240, and present the generated Escrow Code 260, to be captured by the Buyer's Device. The Buyer may then complete the transaction, as described previously, and the POS can confirm settlement by requesting a Transaction Receipt 290 from the System. As a courtesy, the POS may produce a printed receipt for the Buyer.

A variation of this embodiment involves the Buyer pre-selecting payment source(s) and amount(s) on their mobile device. The mobile application on the Buyer's Device 110 can create an encrypted Payment Token representing the Buyer's authorization for payment. The Seller (using a mobile device or dedicated POS) can submit an Offer Template 230, along with the Payment Token, to the System. As with the previously described “bump” gesture, this indicates acceptance by both parties of the Offer Terms and the Payment. The System provides the Escrow Code 260 to both parties (it is associated with the Payment Token), from which each can confirm settlement by requesting a copy of the Transaction Receipt 290.

In another embodiment, the Buyer has a mobile device and the Seller is the e-commerce portion of a website. The “shopping cart” becomes part of the Offer Template 230. At check-out time, the Buyer ID 220 is combined with the Offer Template 230 to create an Offer 240. The Buyer ID is not considered to be private information, so it may be freely shared, stored on the e-commerce site (associated with a user profile, for example), or provided at check-out time. The website submits the Offer 240 to the System and receives an Escrow Code 260 for the Offer. The website's request for an Escrow Code is considered the Seller's signature authorizing the transaction. The website presents the Escrow Code 260 to the Buyer using, for example, an on-screen display of a barcode or other identifier. The Buyer may use that barcode to capture the Escrow Code 260 and complete the Payment process using their mobile device, as previously described. Once payment has been confirmed, the Buyer indicates to the site that payment has been made, and the site uses the Escrow Code 260 to retrieve a Transaction Receipt 290 confirming the transaction.

A variation of this embodiment involves the website presenting the Escrow Code 260 as a web hyperlink (possibly as a QR code). This hyperlink takes the Buyer to a Payment Portal. Through the Payment Portal, the Buyer can be authenticated, select the source(s) and amount(s) for payment, and authorize settlement of the transaction. On returning from the Payment Portal, the e-commerce website confirms the transaction as described above.

In another variation of this embodiment, the Seller is a self-service kiosk or vending machine with a connection to the System. The Buyer's product selections are used to create Offer Template 230. The Buyer ID 220 is provided to the Seller by, for example, scanning a barcode. The Seller displays the Escrow Code 260, and the Buyer uses their mobile device to authorize payment. The Seller confirms settlement, by requesting the Transaction Receipt 290, and then dispenses the purchased product.

In another embodiment, the Seller produces a bill for a Buyer, with whom they already have a relationship, and for whom they have obtained a Buyer ID 220. The Seller has all the information they need to request an Escrow Code 260 for this transaction from the System. The bill may be delivered electronically or physically (printed) or a hyperlink to the bill may be communicated to the Buyer, taking the Buyer to a payment portal. The Escrow Code is included with the bill, and may be a barcode (possibly a QR code) or other identifier, web hyperlink, or both. The Buyer, after receipt of the bill, can authorize Payment using their mobile device, or a Payment Portal, as previously described.

The Seller can query the status of a transaction at any time, eventually receiving the Transaction Receipt 290 after settlement. As a convenience, the System may offer a batch-delivery service in which batches of settled Transaction Receipts are sent periodically to the Seller. The System may also offer a pro-active notification service in which Transaction Receipts are sent to the Seller as they reach their final states.

In at least one embodiment the Seller Account ID 200, Terms and Conditions 210, and Buyer Account ID 220 may be combined into an Offer 240, from which an Escrow Code 260 may be created. As used herein the term “Offer Code” may represent a code (or token) identifying a portion of the data required to complete a transaction, but not enough to generate a Secure Escrow Code. In at least one embodiment this may be similar to the earlier described embodiment describing a Buyer pre-selecting payment sources and amounts for creation of a Payment Token. As used herein the terms “Payment Token” and “Payment Code” may be interchangeable.

In an additional embodiment, the seller may establish an Offer Template 230 having an Offer Code within the secure escrow transaction system. The Offer Code for the Offer Template 230 may then be communicated to the buyer. The buyer may then communicate to the secure escrow transaction system the Offer Code and the Buyer Escrow Account ID 220, along with the buyer payment source, and amount to be Paid 280. The secure escrow transaction system may then complete the Offer 240, if the terms of the Offer Template 230 and the buyer payment authorization satisfy the terms of the Offer Template 230. The secure escrow transaction system may then initiate a transaction settlement, along with communication of the Transaction Receipt 290 to both the seller and buyer.

In other embodiments, one or more actions as identified above to be performed by a seller and buyer may be reversed, so that the buyer is performing an action which was previously identified as being performed by the seller, and the seller is performing an action which was previously identified as being performed by the buyer. In one embodiment, the buyer may initiate a request to purchase, which would constitute the Offer Template 230 to be accepted by a seller, in order to establish the Offer 240 within the secure escrow transaction system. In this embodiment, the buyer may submit payment authorization along with the Offer Template 230 or after a seller's acceptance of an Offer 240. It should be noted that the sequence of one or more of the actions to be completed during a transaction within the secure escrow transaction system may be modified dependent upon any number of contingencies, and that the sequence of actions as identified herein is not restrictive of the number of alternative sequences which may be available or utilized to complete a transaction using the secure escrow transaction system.

What is claimed is:

1. A method of conducting a secure transaction, comprising the steps of:
a) a buyer, having account information on an escrow server including an assigned buyer account number, the buyer authenticates their buyer identity using a buyer device;
b) a seller, having account information on the escrow server including an assigned seller account number, the seller authenticates their seller identity using a seller device;
c) the seller constructs an offer template using their seller device, the offer template comprising the seller account number combined with information sufficient to identify the item(s) being sold, the item(s) price and the total amount of the transaction;
d) the buyer communicates their buyer account number to the seller device;
e) the seller combines the buyer account number with the offer template to create a digitally signed offer, which is sent to the escrow server;
f) the escrow server generates an escrow code for the transaction;
g) the escrow code is sent to the seller device by the escrow server;
h) the seller communicates the escrow code to the buyer device;
i) the buyer uses the escrow code to review the offer, using the escrow server;
j) the buyer authorizes payment using the buyer device, the payment authorization is sent to the escrow server, and
k) the escrow server transfers payment from the buyer account to the seller account.

2. The method of conducting a secure transaction of claim 1 wherein the buyer device and seller device are smartphones, each provided with a display and camera.

3. The method of conducting a secure transaction of claim 2, wherein the buyer communicates the buyer account number to the seller device by the seller taking a picture of the buyer account number displayed on the buyer device display.

4. The method of conducting a secure transaction of claim 3 wherein the buyer account number displayed on the buyer device display is in the form selected from the group consisting of alphanumeric display, a barcode representative of the buyer account number and a QR code representative of the buyer account number.

5. The method of conducting a secure transaction of claim 1, wherein the seller communicates the escrow code to the buyer device by the buyer taking a picture of the escrow code displayed on the seller device display.

6. The method of conducting a secure transaction of claim 5 wherein the escrow code displayed on the seller device display is in the form selected from the group consisting of alphanumeric display, a barcode representative of the buyer account number and a QR code representative of the buyer account number.

7. The method of conducting a secure transaction of claim 1 further including the step of the escrow server generating a receipt and sending it to the buyer device.

8. The method of conducting a secure transaction of claim 1 wherein the seller device and the buyer device are a single smartphone, which the seller and buyer share, and the seller and buyer each separately authenticate the various steps of the transaction.

9. The method of conducting a secure transaction of claim 1 wherein the seller device is a POS (point-of-sale) device and the buyer device is a smartphone, provided with a display and a camera.

10. The method of conducting a secure transaction of claim 1 wherein the seller device is a POS (point-of-sale) device and the buyer device is keypad connected to the POS device, which the buyer uses to communicate the buyer account number and authorize payment.

11. The method of conducting a secure transaction of claim 1 wherein the seller device is an ecommerce website, and the buyer device is a smartphone having a display and a camera;
further wherein the shopping cart is the offer, which is combined with the buyer account number, communicated to the ecommerce site using a keyboard, and the escrow code is displayed on a monitor, and communicated to the buyer device by the buyer taking a picture of the escrow code displayed on the monitor and authorizing payment using the buyer device.

12. The method of conducting a secure transaction of claim 1 in which a bill is generated, the bill containing the escrow code, and communicated to the buyer device by the buyer taking a picture of the escrow code from the bill and authorizing payment using the buyer device.

13. The method of conducting a secure transaction of claim 1 in which a bill is generated, the bill containing the escrow code and a hyperlink directing the buyer to a payment portal.

14. A system for conducting a secure transaction, comprising:
an escrow server, having account information for both a buyer and a seller;
the buyer having a buyer device, which authenticates the buyer identity;
the seller having a seller device, which authenticates the seller identity;
the seller constructs an offer template using their seller device, the offer template comprising the seller account number combined with information sufficient to identify the item(s) being sold, the item(s) price and the total amount of the transaction;
the buyer communicates their buyer account number to the seller device;
the seller combines the buyer account number with the offer template to create a digitally signed offer, which is sent to the escrow server;
the escrow server generates an escrow code for the transaction;
the escrow code is sent to the seller device by the escrow server;
the seller communicates the escrow code to the buyer device;
the buyer uses the escrow code to review the offer, using the escrow server;
the buyer authorizes payment using the buyer device, the payment authorization being sent to the escrow server, and
the escrow server transfers payment from the buyer account to the seller account.

15. A method of conducting a secure transaction, comprising the steps of:
a) a first party, having account information on an escrow server including an assigned first party account number;
b) a second party, having account information on the escrow server including an assigned second party account number;
c) one of the first party and the second party constructs an offer template at an escrow server, the offer template comprising the account number for the first party or the second party constructing the offer template combined with information sufficient to identify the item(s) being sold, the item(s) price and the total amount of the transaction;
d) the party not constructing the offer template communicates their account number to the party constructing the offer template;
e) the party constructing the offer template combines the account number for the party not constructing the offer template with the offer template to create a digitally signed offer, which is sent to the escrow server;
f) the escrow server generates an escrow code for the transaction;
g) the escrow server sends the escrow code to the party constructing the digitally signed offer;
h) the party constructing the digitally signed offer communicates the escrow code to the party not constructing the digitally signed offer, and
i) the party not constructing the digitally signed offer uses the escrow code to review the digitally signed offer, using the escrow server.

16. The method of claim 15 wherein
j) the first party is a seller and the second party is a buyer and the buyer sends a payment authorization to the escrow server, and
k) the escrow server transfers payment from the buyer's account to the seller's account.

17. The method of claim 15 wherein
j) the first party is a buyer and the second party is a seller and the buyer sends a payment authorization to the escrow server, and
k) the escrow server transfers payment from the buyer's account to the seller's account.

18. The method of conducting a secure transaction of claim 15 wherein the first party and the second party send information to the escrow server using a single device which the first party and the second party share and the first party and the second party each separately authenticate the various steps of the transaction.

19. A method of conducting a secure transaction, comprising the steps of:
a) a buyer, having account information on an escrow server including an assigned buyer account number, the buyer authenticates their buyer identity using a buyer device;
b) a seller, having account information on the escrow server including an assigned seller account number, the seller authenticates their seller identity using a seller device;
c) the seller constructs an offer using their seller device, the offer comprising the seller account number combined with information sufficient to identify the item(s) being sold, the item(s) price and the total amount of the transaction;
d) the buyer constructs a payment authorization on the buyer device;
e) the buyer device and the seller device are placed in proximity to one another to initiate a bump transaction, whereupon the seller device communicates the offer to the escrow server and the buyer device communicates the payment authorization to the escrow server and the escrow server combines the offer and the payment authorization, and the escrow server generates an escrow code for the transaction, transfers payment from the buyer account to the seller account, and sends the escrow code to both the buyer and seller device.
